(19) United States
(12) Patent Application Publication
(10) Pub. No.: US 2019/0180202 A1
(43) Pub. Date: Jun. 13, 2019

(54) PREDICTION DEVICE AND PREDICTION METHOD

(71) Applicant: Panasonic Intellectual Property Management Co., Ltd., Osaka (JP)

(72) Inventors: YOSHIYUKI OKIMOTO, Nara (JP); HIDEHIKO SHIN, Osaka (JP); TOMOAKI ITOH, Tokyo (JP); KOICHIRO YAMAGUCHI, Osaka (JP)

(21) Appl. No.: 16/274,470

(22) Filed: Feb. 13, 2019

Related U.S. Application Data
(63) Continuation of application No. PCT/JP2017/034045, filed on Sep. 21, 2017.

(30) Foreign Application Priority Data
Jan. 13, 2017 (JP) 2017-004354

(51) Int. Cl. G06Q 10/04; G06Q 10/06; G06K 9/62; G06N 7/00

(52) U.S. Cl. CPC G06Q 10/04; G06N 7/005; G06K 9/6297; G06Q 10/06375

(57) ABSTRACT

A prediction device is a device that predicts a flow of a person after a layout change of goods in a region, and the prediction device includes: an obtaining unit that obtains traffic line information representing flows of a plurality of persons in the region, layout information representing layout positions of the goods, and change information representing a layout change of the goods; and a controller that generates an action model of a person in the region, by an inverse reinforcement learning method, based on the traffic line information and the layout information and that predicts a flow of a person after the layout change of the goods, based on the action model and the change information.

### TECHNICAL FIELD

The present disclosure relates to a prediction device and a prediction method that predict a flow of a shopper.

### BACKGROUND ART

PTL 1 discloses a customer simulator system that calculates a probability of a customer staying at each of a plurality of shelves in a shop, based on a probability of a customer staying in the shop, a staying time of a customer in the shop, distances among the shelves in the shop, and other information. With this, it is possible to calculate a customer unit price after a layout of goods on the shelves is changed, and it is thus possible to predict the sales after the layout change.

### CITATION LIST

### Patent Literature

PTL 1: Japanese Patent No. 5905124

### SUMMARY

The present disclosure provides a prediction device and a prediction method that predict a flow of a shopper after a change of goods layout.

A prediction device of the present disclosure is a prediction device that predicts a flow of a person after a layout change of goods in a region, and the prediction device includes: an obtaining unit that obtains traffic line information representing flows of a plurality of persons in the region, layout information representing layout positions of the goods, and change information representing a layout change of the goods; and a controller that generates an action model of a person in the region, by an inverse reinforcement learning method, based on the traffic line information and the layout information and that predicts a flow of a person after the layout change of the goods, based on the action model and the change information.

A prediction method of the present disclosure is a prediction method for predicting a flow of a person after a layout change of goods in a region, and the prediction method includes: a step of obtaining traffic line information representing flows of a plurality of persons in the region, layout information representing layout positions of the goods, and change information representing a layout change of the goods; a step of generating an action model of a person in the region by an inverse reinforcement learning method, based on the traffic line information and the layout information; and a step of predicting a flow of a person after the layout change of the goods, based on the action model and the change information.

The prediction device and the prediction method of the present disclosure enable prediction of a flow of a shopper after a change of goods layout with a high degree of accuracy.

### BRIEF DESCRIPTION OF DRAWINGS

FIG. 1 is a block diagram illustrating a configuration of a prediction device in a first exemplary embodiment of the present disclosure.

FIG. 2 is a diagram for describing areas of a shop in the first exemplary embodiment.

FIG. 3 is a flowchart for describing generation of an action model of a shopper in the first exemplary embodiment.

FIG. 4 is a diagram showing an example of characteristic vectors indicating states in the first exemplary embodiment.

FIG. 5 is a diagram showing an example of traffic line information in the first exemplary embodiment.

FIG. 6 is a diagram showing an example of purchased goods information in the first exemplary embodiment.

FIG. 7 is a flowchart for describing traffic line prediction of the first exemplary embodiment of a shopper after a change of goods layout.

FIG. 8 is a flowchart for describing a specific example of the traffic line prediction of FIG. 7.

FIG. 9 is a diagram for describing how to determine a strategy in the first exemplary embodiment based on a reward.

FIG. 10A is a diagram showing a display example of predicted actions and traffic lines in the first exemplary embodiment.

FIG. 10B is a diagram showing a display example of the predicted actions and traffic lines in the first exemplary embodiment.

### DESCRIPTION OF EMBODIMENTS

Hereinafter, exemplary embodiments will be described in detail with appropriate reference to the drawings. However, an unnecessarily detailed description will not be given in some cases. For example, a detailed description of a well-known matter and a duplicated description of substantially the same configuration will be omitted in some cases. This is to avoid the following description from being unnecessarily redundant and thus to help those skilled in the art to easily understand the description.

Note that the inventors provide the accompanying drawings and the following description to help those skilled in the art to sufficiently understand the present disclosure, but do not intend to use the drawings or the description to limit the subject matters of the claims.

### (Circumstance Leading Up to Present Disclosure)

The inventors considered that because a change of goods layout in a shop changes actions of shoppers, it is necessary to consider changes in the shoppers' actions associated with the layout change in order to optimize the layout of the goods with a high degree of accuracy. However, in PTL 1, the action of a shopper is simulated based on the condition that the probability of the shopper moving to a shelf of a plurality of shelves is higher when the moving distance to the shelf is shorter.

However, the shelf that a shopper visits depends on a purpose of purchase of the shopper. Therefore, a shopper does not always take a course with the shortest movement path when shopping. Consequently, if the simulation is performed based on the condition that, of a plurality of shelves, the shopper moves at a higher probability to the shelf that the shopper can reach with a smaller moving distance, it is not possible to simulate the flow of the shopper with a high degree of accuracy.

In view of the above issue, the present disclosure provides a prediction device that enables accurate prediction of a flow of a shopper after a change of goods layout. Specifically, a prediction device of the present disclosure predicts the flow of a shopper after a change of goods layout, on the basis of an actual goods layout (shop layout) and actual traffic lines of shoppers by an inverse reinforcement learning method.

Hereinafter, a prediction device of the present disclosure will be described in detail.

### First Exemplary Embodiment

### 1. Configuration

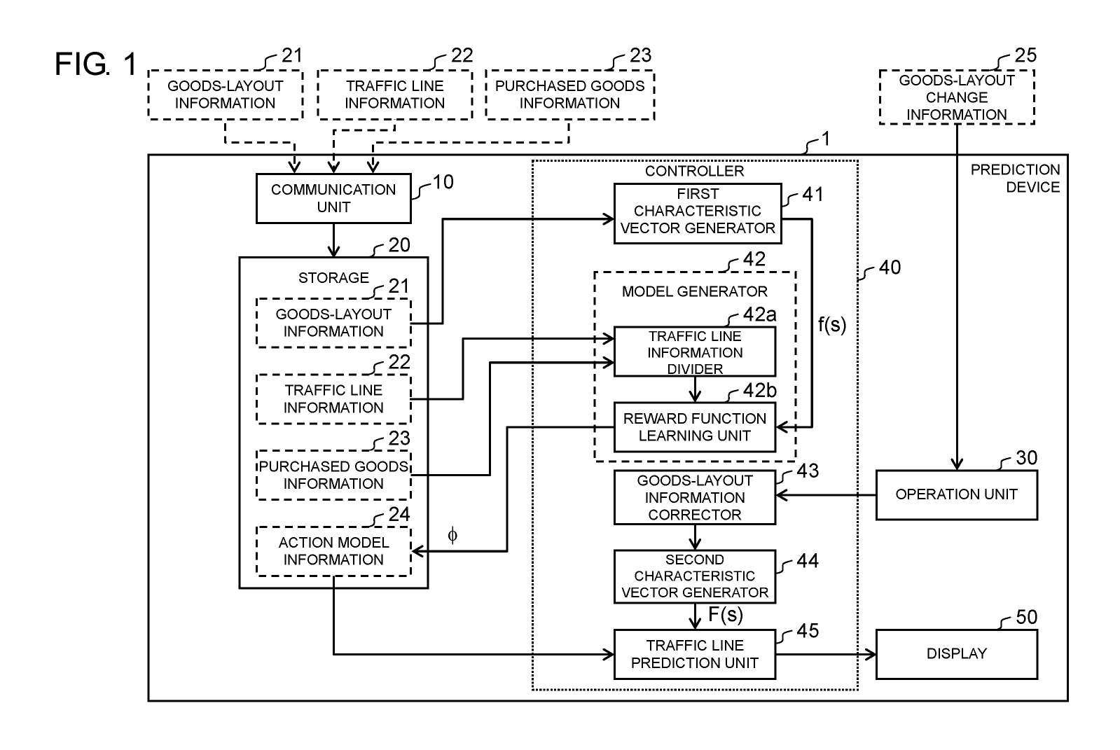

FIG. 1 is a block diagram illustrating a configuration of a prediction device of the present exemplary embodiment. With reference to FIG. 1, prediction device 1 of the present exemplary embodiment includes communication unit 10, storage 20, operation unit 30, controller 40, and display 50.

Communication unit 10 includes an interface circuit used for communication with an external device based on a predetermined communication standard, for example, a local area network (LAN), WiFi, Bluetooth (registered trademark), and a universal serial bus (USB). Communication unit 10 obtains goods-layout information 21, traffic line information 22, and purchased goods information 23.

Goods-layout information 21 is information representing actual layout positions of goods. Goods-layout information 21 includes, for example, identification numbers (ID) of goods and identification numbers (ID) of shelves on which the goods are disposed.

Traffic line information 22 is information representing flows of shoppers in a shop. Traffic line information 22 is generated from a video of a camera installed in the shop or other information.

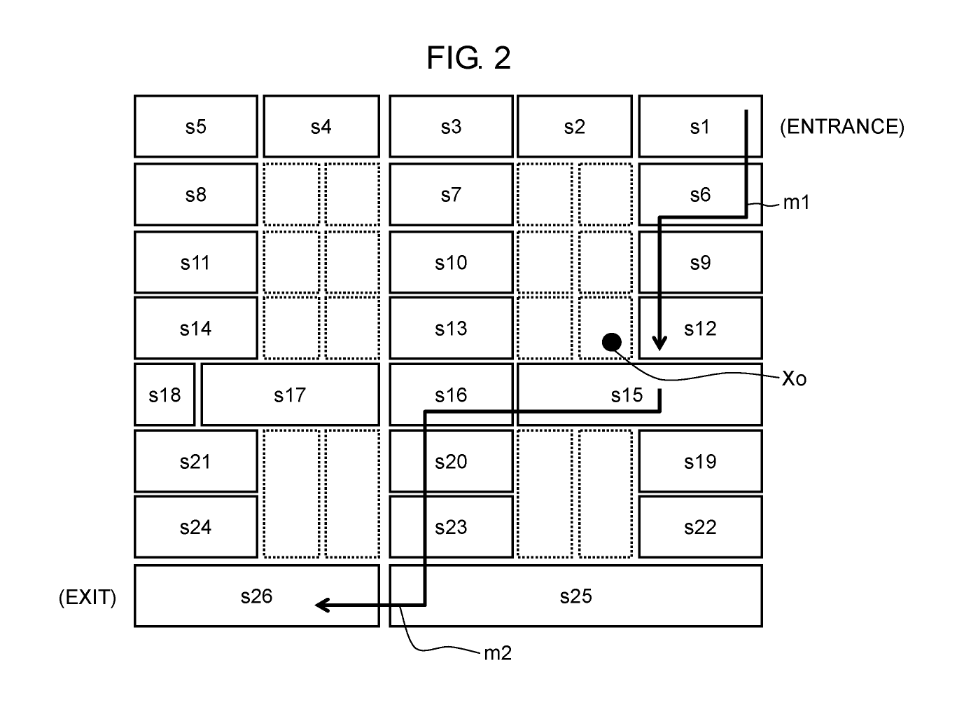

FIG. 2 is a diagram showing an example of areas of the shop in the first exemplary embodiment. With reference to FIG. 2, isles in the shop are shown being divided into a plurality of areas s1 to s26. The way how the isles shown in FIG. 2 are divided into areas is just an example, and the isles can be divided into an arbitrary number of areas that are arbitrarily laid out.

Traffic line information 22 represents flows of shoppers by, for example, the identification numbers s1 to s26 of the areas (isles) that the shoppers have passed through.

Purchased goods information 23 is information representing the goods that a shopper purchased in the shop. Purchased goods information 23 is obtained from a point of sales (POS) terminal device or the like in the shop.

Storage 20 stores goods-layout information 21, traffic line information 22, and purchased goods information 23 obtained through communication unit 10 and action model information 24 generated by controller 40. Storage 20 is implemented by, for example, a hard disk drive (HDD), a solid state drive (SSD), a random access memory (RAM), a dynamic random access memory (DRAM), a ferroelectric memory, a flash memory, a magnetism disk, or a combination of these storage devices.

Operation unit 30 receives an input to prediction device 1 by a user. Operation unit 30 is configured with a keyboard, a mouse, a touch panel, and other devices. Operation unit 30 obtains goods-layout change information 25.

Goods-layout change information 25 represents goods whose positions or layout will be changed, and represents places of the goods after the layout change. Specifically, goods-layout change information 25 includes, for example, identification numbers (ID) of goods whose positions or layout will be changed and identification numbers (ID) of the shelves after the layout change.

Controller 40 includes: first characteristic vector generator 41 that generates from goods-layout information 21 a characteristic vector (area characteristic information) f(s) representing a characteristic of each of areas s1 to s26 in the shop; and model generator 42 that generates an action model of a shopper on the basis of traffic line information 22 and purchased goods information 23.

The characteristic vector f(s) includes at least information representing an item of purchasable goods in each of areas s1 to s26. Note that the characteristic vector f(s) may include, in addition to the information representing purchasable goods in the areas, information representing distances from the areas to goods shelves, an entrance and exit, or a cash desk and may include information representing planar dimensions of the areas and other information.

Model generator 42 includes traffic line information divider 42a and reward function learning unit 42b. Traffic line information divider 42a divides traffic line information 22 on the basis of purchased goods information 23. Reward function learning unit 42b learns reward r(s) on the basis of the characteristic vector f(s) and divided traffic line information 22.

An “action model of a shopper” corresponds to a reward function expressed by following Equation (1).

r(s)=ϕ(f(s)) Equation (1)

In Equation 1, the reward r(s) is expressed as a mapping ϕ(f(s)) of the characteristic vector f(s). Reward function learning unit 42b obtains action model information 24 of a shopper, by learning the reward r(s), from a plural series of data about a traffic line of the shopper, in other words, an area transition. Action model information 24 is a function (mapping) ϕ in Equation (1).

Controller 40 further includes second characteristic vector generator 44 and traffic line prediction unit 45.

Together with goods-layout information corrector 43 that corrects goods-layout information 21 on the basis of goods-layout change information 25 having been input via operation unit 30, second characteristic vector generator 44 generates a characteristic vector F(s) representing the characteristic of each area in the shop when the goods layout is changed, on the basis of corrected goods-layout information 21. Traffic line prediction unit 45 predicts a traffic line (flow) of a shopper on the basis of the characteristic vector F(s) after a change of goods layout and on the basis of action model information 24 after a change of goods layout. Note that instead of correcting the actual goods-layout information 21 on the basis of the goods-layout change information 25, goods-layout information corrector 43 may newly generate goods-layout information 21 after the layout change.

Controller 40 can be implemented by a semiconductor device or other devices. Functions of controller 40 may be configured with only hardware or may be achieved by a combination of hardware and software. Controller 40 can be configured with, for example, a microcomputer, a central processor unit (CPU), a micro processor unit (MPU), a digital signal processor (DSP), a field-programmable gate array (FPGA), and an application specific integrated circuit (ASIC).

Display 50 displays, for example, the predicted traffic line or a result of an action. Display 50 is configured with a liquid crystal display, an organic electroluminescence (EL) display, or other devices.

Communication unit 10 and operation unit 30 correspond to an obtaining unit that obtains information from outside. Controller 40 corresponds to an obtaining unit that obtains information stored in storage 20. Further, communication unit 10 corresponds to an output unit that outputs a prediction result to outside. Controller 40 corresponds to an output unit that outputs a prediction result to storage 20. Display 50 corresponds to an output unit that outputs a prediction result on a screen.

### 2. Operation

### 2.1 Overall Operation

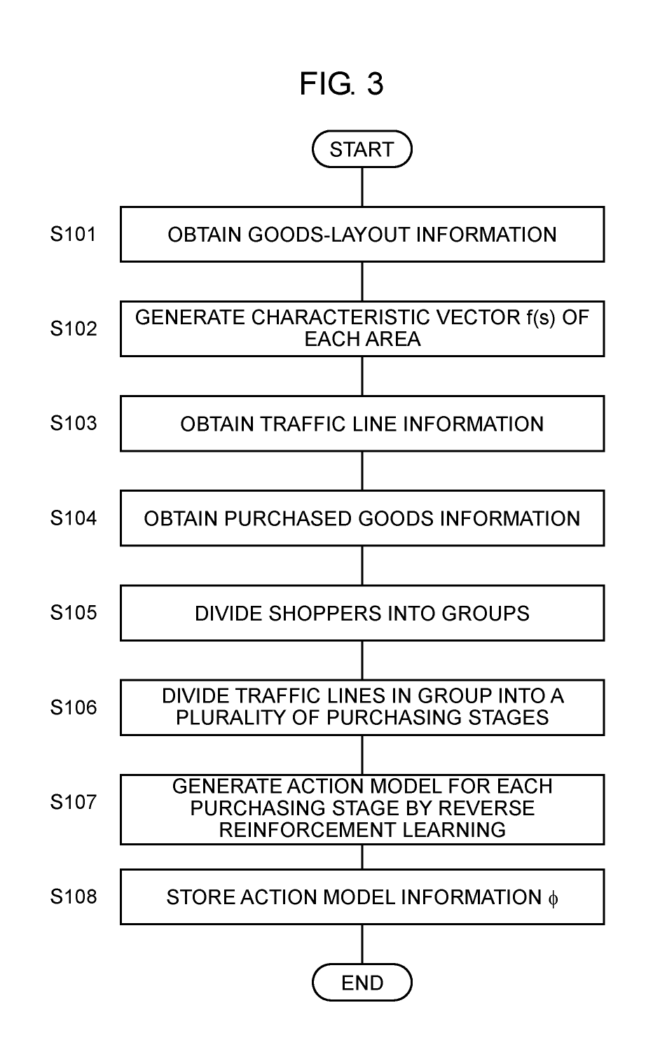

FIG. 3 is a flowchart for describing generation of an action model of a shopper in the exemplary embodiment. With reference to FIG. 3, prediction device 1 first generates an action model of a shopper on the basis of actual layout positions of goods in a shop and traffic lines of shoppers in the shop.

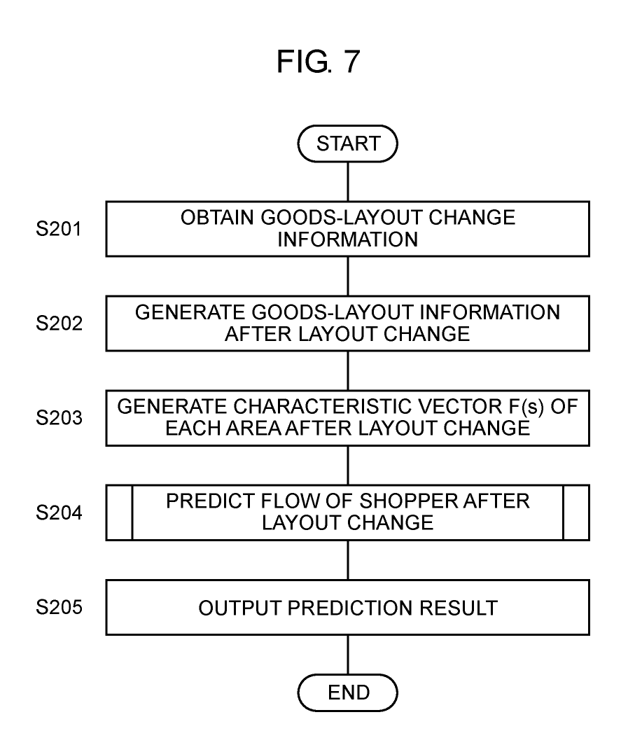

FIG. 7 is a flowchart for describing prediction of a traffic line of a shopper after a change of goods layout. With reference to FIG. 7, prediction device 1 predicts the traffic line of a shopper when the goods layout is changed, on the basis of the action model shown in FIG. 3.

### 2.2 Generation of Action Model

First, a description will be given on how to generate the action model of a shopper. The action model of a shopper is generated by an inverse reinforcement learning method. The inverse reinforcement learning method is for estimating a “reward” from a “state” and an “action”.

In the present exemplary embodiment, the “state” shows that a shopper is in a specific area of the areas made by discretely dividing the inside of the shop. Further, a shopper moves from one area to another (transitions between states) according to the “action”. The “reward” is an imaginary numerical quantity for describing a traffic line of a shopper, and a shopper is assumed to repeat the “action” that maximizes a total sum of “rewards” each of which is obtained every time when the shopper makes one state transition. In other words, imaginary “rewards” are each assigned to each area, and the “rewards” are estimated by the inverse reinforcement learning method in such a manner that the series of “actions” (series of state transitions) in which the sum of the “rewards” is large coincides with the traffic line through which shoppers frequently go. As a result, the area whose “reward” is high mostly coincides with the area that shoppers often stay in or pass through.

FIG. 3 shows how controller 40 operates to generate an action model. With reference to FIG. 3, first characteristic vector generator 41 obtains goods-layout information 21 from storage 20 (step S101). First characteristic vector generator 41 generates the characteristic vector f(s) of each area in the shop on the basis of goods-layout information 21 (step S102).

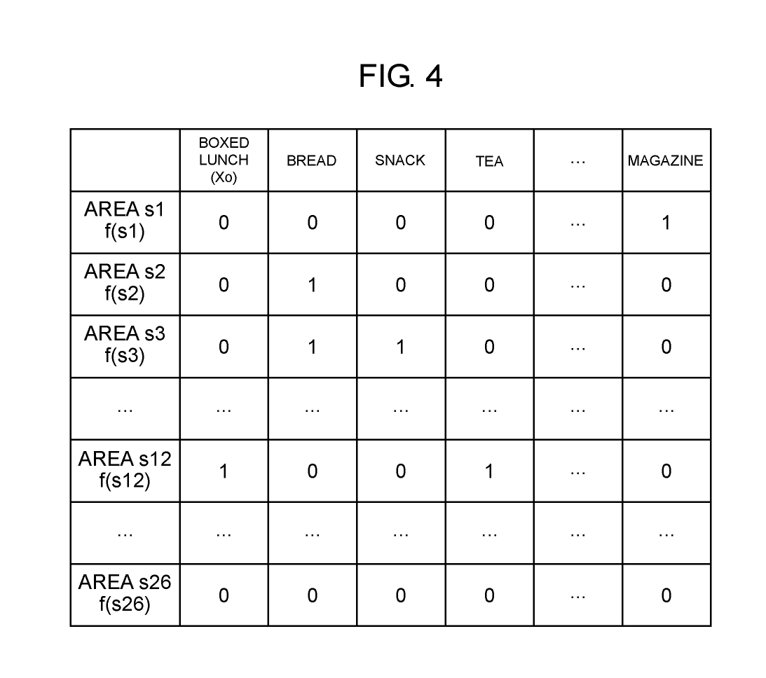

FIG. 4 is a diagram showing an example of the characteristic vector f(s). With reference to FIG. 4, for example, the characteristic vector f (s1) of area s1 is “0, 0, 0, 0, . . . 1”. Here, the figure “1” represents an item of goods that can be obtained in the area, and the figure “0” represents an item of goods that cannot be obtained in the area. Whether an item of goods can be obtained is determined, for example, depending on whether the item of goods is put on a shelf that can be reached from each of the areas s1 to s26 (specifically, a shelf adjacent to each of the areas or a shelf within a predetermined range from each of the areas). Note that the characteristic vector f(s) generated by first characteristic vector generator 41 may be modified by a user via operation unit 30.

With reference to FIG. 3, traffic line information divider 42a obtains traffic line information 22 from storage 20 (step S103).

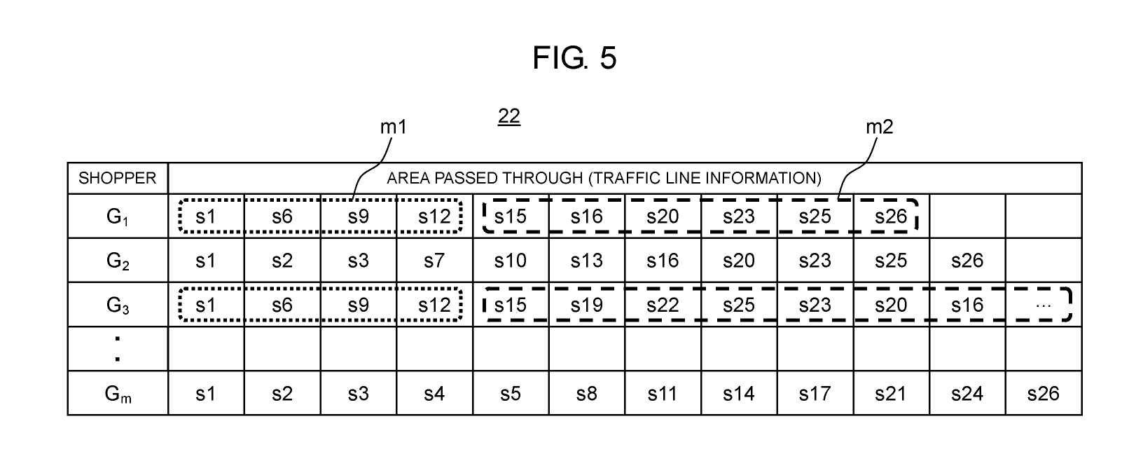

FIG. 5 is a diagram showing an example of traffic line information 22. With reference to FIG. 5, for example, traffic line information 22 represents identification numbers (ID) G₁ to Gₘ of respective shoppers identified in a video and the identification numbers s1 to s26 of the areas (isles) through which the shoppers passed. The identification numbers s1 to s26 of the areas (isles) through which each shopper passed represent, for example, an order in which each shopper passed through. Note that traffic line information 22 only has to be information that specifies the areas through which each shopper passed and the order in which the areas were passed through. For example, traffic line information 22 may include the identification numbers (ID) of shoppers, the identification numbers (ID) of the areas through which the shoppers passed, and time when the shoppers passed through each area.

With reference to FIG. 3, traffic line information divider 42a further obtains purchased goods information 23 from storage 20 (step S104).

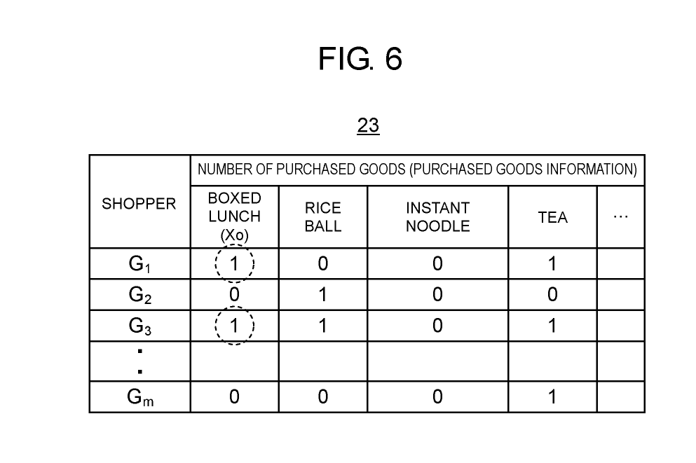

FIG. 6 is a diagram showing an example of purchased goods information 23. With reference to FIG. 6, purchased goods information 23 includes, for example, identification numbers (ID) G₁ to Gₘ of shoppers, names or identification numbers (ID) of the purchased goods, and numbers of the purchased goods. Purchased goods information 23 further includes a date and time (not shown) when each item of goods was purchased.

Here, traffic line information 22 and purchased goods information 23 are associated with each other by the identification numbers G₁ to Gₘ of the respective shoppers and other information. For example, because the fact that the time when a shopper is at a cash desk and the time when purchasing of an item of goods is completely input at the cash desk coincide with each other, controller 40 may associate traffic line information 22 with purchased goods information 23 on the basis of the date and time contained in traffic line information 22 and the date and time contained in purchased goods information 23. Further, controller 40 may obtain, via communication unit 10, traffic line information 22 and purchased goods information 23 that are associated with each other by, for example, the identification numbers of shoppers, and controller 40 may store obtained traffic line information 22 and purchased goods information 23 into storage 20.

With reference to FIG. 3, traffic line information divider 42a groups the shoppers into a plurality of groups on the basis of traffic line information 22 and purchased goods information 23 (step S105). The grouping can be performed by any method. For example, shopper having purchased a predetermined item of goods is grouped into the same group. With reference to FIG. 6, for example, the shoppers G₁ and G₃ having purchased the item Xo are put in the same group.

With reference to FIG. 3, traffic line information divider 42a divides the traffic lines (state transition series) in each group into a plurality of purchasing stages (step S106). The “purchasing stages” includes, for example, a stage of target purchasing, a stage of additional purchasing, and a stage of payment. The staging can be performed by any method. For example, the staging may be performed on the basis of a predetermined condition (whether before or after purchasing of a predetermined item of goods or whether before or after passing of a predetermined area).

Specifically, for example, as shown in FIG. 2 and FIG. 5, with respect to the group of people who purchased the goods Xo, the traffic line of each shopper of the group is divided into a first purchasing stage m1 and a second purchasing stage m2. The first purchasing stage m1 is from entering into the shop to purchasing of the item Xo, and the second purchasing stage m2 is from the purchasing of the item Xo to exiting the shop. Note that a number of the staging does not have to be two. For example, the purchasing stage may be divided into three stages or more.

With reference to FIG. 3, reward function learning unit 42b generates an action model for each of the purchasing stages m1 and m2 by the inverse reinforcement learning method (learning of purchasing actions) by using the characteristic vector f(s) generated in step S102 and the plurality of traffic lines (state transition series) divided into the purchasing stages obtained in step S106 (step S107).

Specifically, reward function learning unit 42b learns the reward function of each state s expressed by Equation (1), by using the characteristic vector f(s) generated in step S102 and by using as learning data a plurality of pieces of traffic line data corresponding to the purchasing stages m1 and m2. In this learning, the mapping ϕ is obtained in such a manner that a probability, of passing through (or staying in) each area, calculated from the reward r(s) estimated by the mapping ϕ coincides most with the probability, of passing through (or staying in) each area, obtained from the learning data.

As a method for obtaining such a mapping ϕ, it is possible to use a method in which updating is repeatedly performed by using a gradient method, and to use a method of learning by a neural net. Note that, as a method of obtaining the probability, of passing through (or staying in) each area, from the reward r(s), a method based on a reinforcement learning method can be used, and a method to be described later in [2.3 Traffic line prediction after change of goods layout] is used as a specific method.

With reference to FIG. 3, reward function learning unit 42b stores ϕ obtained by Equation (1) in storage 20 as action model information 24 (step S108).

2.3. Traffic Line Prediction after Change of Goods Layout

Next, a description will be given on prediction of a traffic line of a shopper in the case that a goods layout is changed. The traffic line of a shopper when a goods layout is changed is obtained by a reinforcement learning method. The reinforcement learning method estimates the “action” from the “state” and the “reward”.

FIG. 7 is a diagram showing an operation of the traffic line prediction by controller 40 after a change of goods layout. With reference to FIG. 7, goods-layout information corrector 43 obtains goods-layout change information 25 via operation unit 30 (step S201). Goods-layout information corrector 43 generates goods-layout information 21 after the change of goods layout by correcting goods-layout information 21 on the basis of obtained goods-layout change information 25 (step S202). Second characteristic vector generator 44 generates the characteristic vector F(s) of each area after the change of goods layout, on the basis of goods-layout information 21 after the change of goods layout (step S203). The generation of the characteristic vector F(s) after the change of goods layout can be performed in the same way as the generation, of the characteristic vector f(s), on the basis of the actual goods-layout.

Further, with reference to FIG. 7, traffic line prediction unit 45 predicts the flow (traffic lines) of a shopper after the change of goods layout by using the characteristic vector F(s) after the change of goods layout and action model information 24 stored in storage 20 in step S108 (step S204). After that, traffic line prediction unit 45 outputs the predicted result to outside via, for example, display 50, storage 20, or communication unit 10 (step S205).

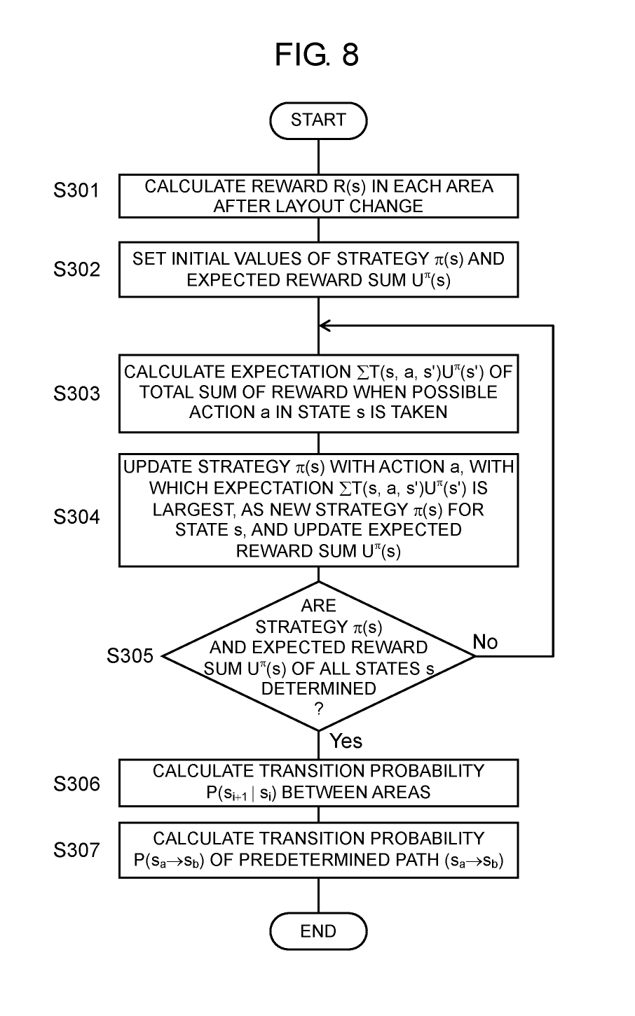

FIG. 8 is a diagram showing in detail the traffic line prediction (step S204), in FIG. 7, of a shopper after the change of goods layout. With reference to FIG. 8, traffic line prediction unit 45 first calculates the reward R(s) for each area (=state s) after the change of goods layout by Equation (2) shown below on the basis of the characteristic vector F(s) after the change of goods layout and action model information 24 (step S301).

R(s)=ϕ(F(s)) Equation (2)

The function (mapping) ϕ in Equation (2) is action model information 24 stored in storage 20 in step S108 in FIG. 3.

In order to predict the traffic lines of a shopper with respect to the purchasing stage m1 shown in FIG. 2 and FIG. 5, the function ϕ obtained for the purchasing stage m1 is used. Further, in order to predict the traffic lines of a shopper with respect to the purchasing stage m2, the function ϕ obtained for the purchasing stage m2 is used. That is, the reward R(s) is calculated by the functions (mapping) ϕ each corresponding to each of the purchasing stages m1 and m2.

With reference to FIG. 8, traffic line prediction unit 45 learns the most appropriate action a by the reinforcement learning method on the basis of the reward R(s) (steps S302 to S305). First, traffic line prediction unit 45 sets initial values of a strategy π(s) and an expected reward sum U^{π}(s) (step S302). The strategy π(s) represents an action a to be taken next in each area (state s). The expected reward sum U^{π}(s) represents the total sum of rewards that can be obtained if actions based on the strategy π are continued taking “s” as the point of origin, and has a meaning shown by Equation (3) shown below.

U^{π}(sᵢ)=R(sᵢ)+γR(sᵢ₊₁)+γ²R(sᵢ₊₂)+ . . . +γⁿR(sᵢ₊ₙ) Equation (3)

Here, γ is a coefficient for temporally discounting a future reward.

Next, traffic line prediction unit 45 calculates, for each action a, an expectation ΣT(s, a, s′)U^{π}(s′) of the total sum of the rewards expected to be obtained when possible actions in the state s are taken (step S303). Traffic line prediction unit 45 updates the strategy π(s) with the action a, with which one of expectations ΣT(s, a, s′)U^{π}(s′) calculated for the respective possible actions a is the largest, as the new strategy π(s) for the state s, and traffic line prediction unit 45 updates the expected reward sum U^{π}(s) (step S304).

Specifically, in steps S303 and S304, traffic line prediction unit 45 updates the optimum strategy π(s) and the expected reward sum U^{π}(s) of each area by Equations (4) and (5) shown below on the basis of the reward R(s) of each area (state s).

$$\begin{matrix}[ Mathematical Expression 1 ] & \\ π ( s ) = {arg max}_{a} {\sum }_{{s}^{′}} T ( s , a , {s}^{′} ) {U}^{π} ( {s}^{′} ) & Equation ( 4 ) \\ [ Mathematical Expression 2 ] & \\ {U}^{π} ( s ) = R ( s ) + γ max {\sum }_{{s}^{′}} T ( s , a , {s}^{′} ) {U}^{π} ( {s}^{′} ) & Equation ( 5 )\end{matrix}$$

T(s, a, s′) represents a probability that the state transitions to the state s′ when an action a is taken in the state s.

In the present exemplary embodiment, the state s represents the area, and the action a represents a traveling direction between areas. Therefore, when the state s (area) and the action a (traveling direction) are determined, the next state s′ (area) is automatically determined uniquely; therefore, T(s, a, s′) can be determined on the basis of the layout of the area in the shop.

Therefore, if the area adjacent, to the area corresponding to the state s, in the direction corresponding to an action a is the state s′, an equation T(s, a, s′)=1 may hold; and an equation T(s, a, s″)=0 may hold for the states s″ corresponding to the other areas.

Traffic line prediction unit 45 determines if the strategy π(s) and the expected reward sum U^{π}(s) are determined for all of the states s (step S305). The determination here means that the strategy π(s) and the expected reward sum U^{π}(s) are converged for all of the states s. Until the strategy π(s) and the expected reward sum U^{π}(s) are determined for all of the states s, step S303 and step S304 are repeated. That is, in Equations (4) and (5), by updating π(s) with the action a, which maximizes the expectation ET(s, a, s′)U^{π}(s′), as the new strategy and by simultaneously updating U^{π}(s), the optimum strategy π(s) and the expected reward sum U^{π}(s) can finally be obtained.

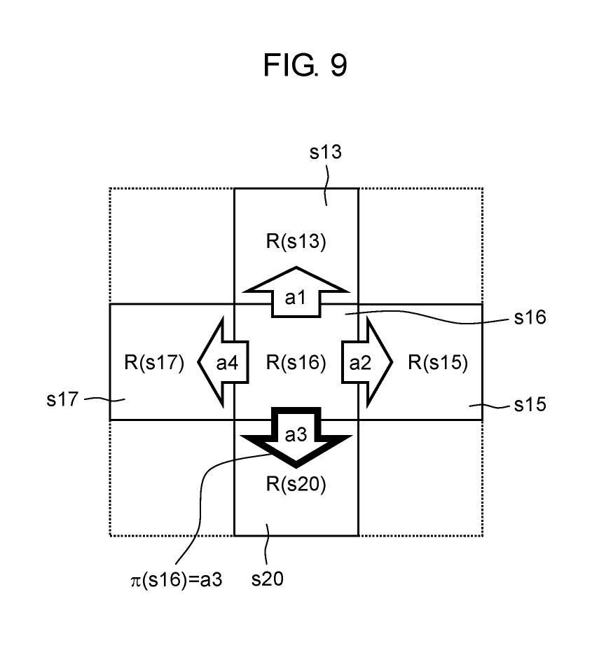

Further, with reference to FIG. 9, a description will be given on an example in which the optimum strategy π(s16) is obtained for the area s16.

FIG. 9 is a diagram showing an image depicting the rewards R(s) for the area s16 and the peripheral areas, the action a that the area s16 (state s) can take, and the optimum strategy π(s). With reference to FIG. 9, the probabilities are set as, for example, T(s16, a1, s13)=1 (100%) and T(s16, a1, s15)=0 depending on the layout of the areas. Note that the probability T does not have to be “1” and “0”. For example, in the case of the area s14 shown in FIG. 2, the probabilities T(s14, a3, s17) and T(s14, a3, s18) that the state transitions to the area s17 and s18 by performing the action a3 may be both determined to be 0.5 previously. The previously determined values of T(s, a, s′) are stored in storage 20.

In the area S16, the actions a1, a2, a3, and a4 can be taken. In this case, the expectations ΣT(s16, a1, s′)U^{π}(s′), ET(s16, a2, s′)U^{π}(s′), ET(s16, a3, s′)U^{π}(s′), and ET(s16, a4, s′)U^{π}(s′) when the actions a1, a2, a3, and a4 are respectively taken are calculated. Note that the symbol E means the sum with respect to s′, in other words, with respect to s13, s15, s17, and s20.

Then, traffic line prediction unit 45 selects the action a corresponding to the largest value of the calculated expectations. For example, if ET(s16, a3, s′)U^{π}(s′) is the largest, updating is performed as π(s16)=a3 and U^{π}(s16)=ET(s16, a3, s′)U^{π}(s′). By repeating the updating based on Equations (4) and (5) for each area as described above, the optimum strategy π(s) and the expected reward sum U^{π}(s) for each area are finally determined.

In the above description, the strategy π(s) is obtained by a method in which only one action is deterministically selected, but the strategy π(s) can be stochastically obtained. Specifically, as the probability that an action a is to be taken in the state s, the strategy π(s) can be determined as Equation (6).

$$\begin{matrix}[ Mathematical Expression 3 ] & \\ \begin{matrix}π ( s ) = P ( a \vert s ) \\ = \frac{{\sum }_{{s}^{′}} T ( s , a , {s}^{′} ) {U}^{π} ( {s}^{′} )}{{\sum }_{a} {\sum }_{{s}^{′}} T ( s , a , {s}^{′} ) {U}^{π} ( {s}^{′} )}\end{matrix} & Equation ( 6 )\end{matrix}$$

However, the denominator of the right-hand side in Equation (6) is such a normalization term that normalizes the total sum of P(a|s) to be 1 with respect to a.

With respect to FIG. 8, when the optimum strategy π(s) is obtained, traffic line prediction unit 45 calculates a transition probability P(sᵢ₊₁|sᵢ) between the adjacent areas (from one state sᵢ to the next state sᵢ₊₁) after the layout change, by Equation (7) shown below (step S306).

$$\begin{matrix}[ Mathematical Expression 4 ] & \\ P ( {s}_{i + 1} \vert {s}_{i} ) = {\sum }_{a} T ( {s}_{i} , a , {s}_{i + 1} ) P ( a \vert {s}_{i} ) & Equation ( 7 )\end{matrix}$$

The probability T(sᵢ, a, sᵢ₊₁) is a probability that the state is transitioned to the state sᵢ₊₁ when an action a is taken in the state s, and the value of the probability T(sᵢ, a, sᵢ₊₁) is previously determined as described above.

Note that in the case that the above-described deterministic strategy π(s), in which only one action is selected, is taken, P(sᵢ₊₁|sᵢ) can be obtained by setting the transition probability as follows. When only such action is taken, the transition probability is set as P(a|sᵢ)=1, and when an action other than such action is taken, the transition probability is set as P(a|sᵢ)=0.

Traffic line prediction unit 45 calculates the transition probability P(sₐ→s_{b}) of a predetermined path (area sₐ→s_{b}) on the basis of the transition probability P(sᵢ₊₁|sᵢ) calculated in step S306 (step S307). Specifically, by calculating the product of the transition probabilities from the area sₐ to the area s_{b} by using Equation (7), the transition probability P(sₐ→s_{b}) of the path sₐ→s_{b} is calculated. For example, traffic line prediction unit 45 calculates the transition probability P(s1→s12) of the traffic line from entering the shop to purchasing the item Xo by P(s1)×P(s6|s1)×P(s9|s6)×P(s12|s9). Note that the predetermined path (area sₐ→s_{b}) for which the transition probability P(sₐ→s_{b}) should be calculated may be specified via operation unit 30.

Alternatively, it is also possible to form the transition probabilities in a matrix and to obtain the transition probability P(sₐ→s_{b}) by repeatedly performing matrix product of the matrix. The matrix of the transition probabilities is a matrix whose component (i, j) is P(sⱼ|sᵢ), and the sum of all probabilities of leaving from the area sₐ and arriving at the area s_{b} after passing through any path can be obtained by repeating the product of this matrix.

When the transition probability P(sₐ→s_{b}) is high, it means that many shoppers pass through the path (area sₐ→s_{b}). On the other hand, the transition probability P(sₐ→s_{b}) is low, it means that almost no shopper passes through the path (area sₐ→s_{b}). As an output of the prediction result (step S205 of FIG. 7), the information containing the transition probability P(sₐ→s_{b}) of the predetermined path calculated in step S307 is output, for example.

Note that the prediction result to be output in step S205 of FIG. 7 may be the information representing the optimum strategy π(s) obtained in step S303 to step S305. In this case, steps S306 and S307 may be omitted. Alternatively, the prediction result to be output may be the information representing the transition probability P(sᵢ₊₁|sᵢ), after the change of goods layout, calculated in step S306. In this case, step S307 may be omitted.

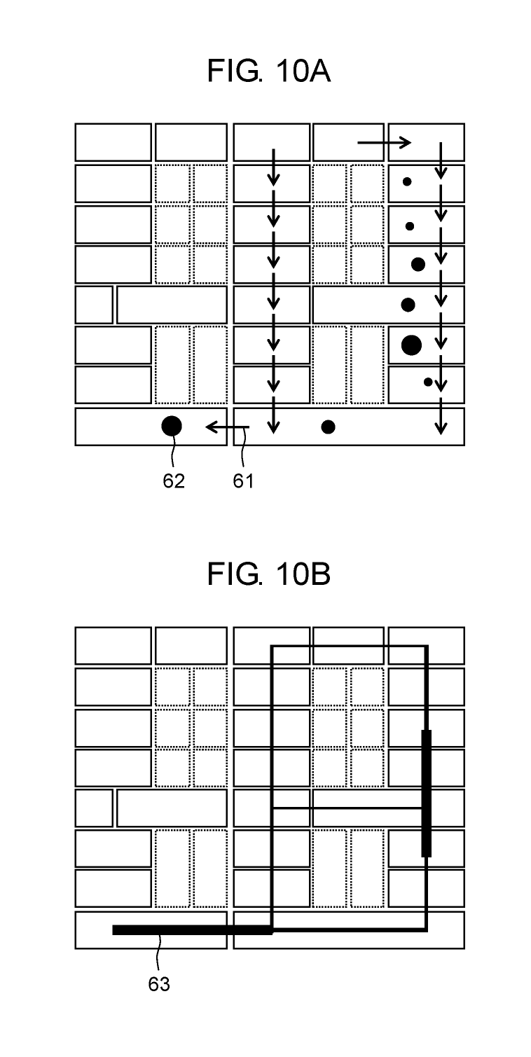

FIG. 10A and FIG. 10B each show an example of display of the prediction result by display 50. In FIG. 10A, the action a of the optimum strategy π(s) of each area is represented by arrow 61, and the reward R(s) of each area is represented by circular shape 62. To make a size of circular shape 62 show a magnitude of the reward R(s), the size of circular shape 62 is made larger for the larger reward R(s), for example. However, circular shape 62 may be displayed thicker for the larger reward R(s).

In FIG. 10B, a part of the transition probabilities P(sᵢ₊₁|sᵢ) between neighboring areas is represented by line 63. To make line 63 show a height of the transition probability P(sᵢ₊₁|sᵢ), line 63 is displayed thicker for the higher transition probability P(sᵢ₊₁|sᵢ), for example. Note that line 63 may be displayed darker as the transition probability P(sᵢ₊₁|sᵢ) is larger.

### 3. Effects and the Like

Prediction device 1 of the present disclosure is a prediction device that predicts a flow of a person after a layout change of goods in a shop (an example of a region), and the prediction device includes: communication unit 10 (an example of an obtaining unit) that obtains traffic line information 22 representing flows of a plurality of persons in the shop, and goods-layout information 21 representing layout positions of the goods, operation unit 30 (an example of an obtaining unit) that obtains goods-layout change information 25 representing a layout change of the goods; and controller 40 that generates an action model (action model information 24=ϕ) of a person in the shop on the basis of traffic line information 22 and goods-layout information 21 by an inverse reinforcement learning method and that predicts a flow of a person after the layout change of the goods, based on the action model and the goods-layout change information 25.

This arrangement makes it possible to accurately predict a flow of a person when a layout of goods is changed, without actuary changing the goods layout. In addition, on the basis of the predicted flow of a person, it is possible to change the positions of the goods to such positions that improve the sales. Alternatively, when a bargain sale, an event, or the like is held in view of concurrent selling, prediction device 1 can be used to consider a layout change, for example, to determine where to hold the above bargain sale and so on so that the customer unit price will be increased by smoothening or disrupting the flow of people in the shop.

The action model is specifically generated as follows. A shop (an example a region) contains a plurality of areas (an example of zones, and, for example, the areas s1 to s26 shown in FIG. 2), and traffic line information 22 represents at least one of the plurality of areas. The at least one of plurality of areas is zones through which each of a plurality of persons passes. Controller 40 employs the plurality of areas as a plurality of “state” in the inverse reinforcement learning method, respectively. Controller 40 further generates action model information 24 (function (mapping) ϕ) by learning a plurality of rewards r(s) associated with the plurality of states on the basis of traffic line information 22. More specifically, controller 40 generates, on the basis of goods-layout information 21, the characteristic vector f(s) (zonal characteristic information) that represents at least one item of the goods obtainable in each of the plurality of areas, and the states in the inverse reinforcement learning method are represented by the characteristic vector f(s).

Before the action model is generated, communication unit 10 (an example of an obtaining unit) further obtains purchased goods information 23 representing one or more goods among the goods that a plurality of persons in the shop purchased. Then, controller 40 groups the plurality of persons on the basis of purchased goods information 23 and generates the action model on the basis of traffic line information 22 after the grouping.

This operation makes it possible, for example, to generate the action model of a group that purchased the same item of goods (that is, the action model about a group having the same purpose of purchase); therefore, it is possible to generate a more accurate action model.

Further, controller 40 divides each of the flows of the plurality of persons into a plurality of purchasing stages on the basis of traffic line information 22 and generates an action model for each of the plurality of purchasing stages. The magnitude of the reward changes depending on the purchasing stages. For example, it is considered that, even in the same area, the magnitude of the reward changes between before and after the purchase of a target item of goods. Therefore, by generating the action model for each purchasing stage, more accurate action models can be generated.

The prediction of the flow of a person, after a change of goods layout, on the basis of the action models is specifically performed as follows. With reference to FIG. 1, controller 40 first calculates the plurality of rewards R(s) after the layout change of goods on the basis of action model information 24 (function (mapping) (I)) and goods-layout change information 25. Controller 40 determines the strategy π(s) that represents the action that a person in the shop is to take in each of the plurality of states, on the basis of the plurality of rewards R(s) after the layout change of goods. Controller 40 calculates the transition probability P(sᵢ₊₁|sᵢ) of a person between two of the plurality of areas after the layout change of goods, on the basis of the determined strategy π(s). In addition, prediction device 1 further includes an output unit (for example, communication unit 10, controller 40, and display 50) that outputs the predicted result (for example, transition probabilities) representing the flow of a person.

This arrangement makes it possible to show the flow of a person after the goods layout is changed. Therefore, on the basis of the predicted flow of a person, a proprietor of the shop can actually change the positions of the goods to such positions that improve the sales, for example.

A prediction method of the present disclosure is a prediction method in which a flow of a person after a layout change of goods in a shop (an example of a region) is changed. Specifically, the prediction method includes: step S101 for obtaining goods-layout information 21 representing layout positions of goods shown in FIG. 3; step S103 for obtaining traffic line information 22 representing flows of a plurality of persons in a shop; step S201 for obtaining goods-layout change information 25 representing a layout change of goods; steps S102 and S107 for generating an action model of a person in the shop by an inverse reinforcement learning method, based on traffic line information 22 and goods-layout information 21; and steps S202 to S204 for predicting a flow of a person in the shop after the layout change of goods, based on the action model and goods-layout change information 25 as shown in FIG. 7.

This arrangement makes it possible to accurately predict a flow of a person when a layout of goods is changed, without actuary changing the goods layout. In addition, on the basis of the predicted flow of a person, it is possible to change the positions of the goods to such positions that improve the sales.

### Other Exemplary Embodiments

The first exemplary embodiment has been described above as an illustrative example of the techniques disclosed in the present application. However, the techniques of the present disclosure can be applied not only to the above exemplary embodiment but also to exemplary embodiments in which modification, replacement, addition, or removal is appropriately made. Further, the components described in the above first exemplary embodiment can be combined to configure a new exemplary embodiment. Therefore, other exemplary embodiments will be illustrated below.

### [1] Other Examples of Grouping

In step S105 of the above first exemplary embodiment, the shoppers having purchased a predetermined item of goods is put in the same group. However, the grouping does not have to be performed by the method in the above first exemplary embodiment. As long as traffic line information 22 and purchased goods information 23 are used for grouping, any method can be used for grouping.

For example, the multimodal LDA (Latent Dirichlet Allocation) may be used to group the shoppers having a similar motive for visiting the shop into the same group. With respect to FIG. 1, traffic line information divider 42a can use the multimodal LDA to show characteristics of shoppers by an N-dimensional vector (for example, N=20) on the basis of traffic line information 22 and purchased goods information 23 in a predetermined period (for example, one month). The classification of the N-dimensional vector based on traffic line information 22 and purchased goods information 23 corresponds to the classification based on N pieces of motives for visiting the shop. Traffic line information divider 42a can group shoppers on the basis of similarity between the vectors of motives for visiting the shop. Further, for example, traffic line information divider 42a may perform grouping on the basis of the largest numerical value of the vector expressions of each shopper.

Further, as other grouping methods, traffic line information divider 42a may use, for example, a method called as Non-negative Tensor Factorization, unsupervised learning by using a neural network, and a clustering method (the K-means method or other methods).

### [2] Other Example of Staging

In the above first exemplary embodiment, in step S106 of FIG. 3, the staging into a plurality of purchasing stages is performed on the basis of a predetermined condition (whether before or after purchasing of a predetermined item of goods Xo). However, the staging does not have to be performed by the method in the above first exemplary embodiment. For example, a hidden Markov model (HMM) may be used for staging.

In the case that HMM is used, Equation (8) shown below can express the probability P(s1, . . . , s26) at the time when a shopper's action is observed in, for example, the state transition series {s1, . . . , s26}.

$$\begin{matrix}[ Mathematical Expression 5 ] & \\ {\prod }_{i} P ( {m}_{i} \vert {m}_{i - 1} ) P ( {s}_{j} \vert {m}_{i} ) & Equation ( 8 )\end{matrix}$$

In the equation, P (mᵢ|mᵢ₋₁) is the probability of transition from the purchasing stage mᵢ₋₁ (for example, a stage of purchasing a target item of goods) to the purchasing stage mᵢ (for example, a stage of payment).

P(sⱼ|mᵢ) is the probability of staying in or passing through the area sⱼ in the purchasing stage mᵢ (for example, the probability of staying in or passing through s26 in the stage of payment).

The transition probability P(mᵢ|mᵢ₋₁) and an output probability P(sⱼ|mᵢ) that maximize the value of Equation (8) will be obtained.

First, the Baum-Welch algorithm or the Viterbi algorithm is used to divide the state transition series according to the initial values of P(mᵢ|mᵢ₋₁) and P(sⱼ|mᵢ) and to recalculate P(mᵢ|mᵢ₋₁) and P(sⱼ|mᵢ) according to the division until convergence. By this calculation, the state transition series can be divided into each purchasing stage m.

Here, P(sⱼ|mᵢ) includes both of the probability P(sⱼ|mᵢ₋₁mᵢ) and the probability P(sⱼ|sⱼ₋₁), where the probability P(sⱼ|mᵢ₋₁mᵢ) is the probability that the purchasing stage mᵢ starts at the area sⱼ (the probability that the first area when the state transitions from the previous purchasing stage mᵢ₋₁ to the next purchasing stage mᵢ is the area sⱼ), and the probability P(sⱼ|sⱼ₋₁) is the probability that the area when the state transitions from the purchasing stage mᵢ to the same purchasing stage mᵢ is the area sⱼ. P(sⱼ|mᵢ₋₁mᵢ) is obtained by counting the occurrence of the area sⱼ as the start area of the purchasing stage mᵢ, on the basis of traffic line information 22 in the same group. P(sⱼ|sⱼ₋₁) can be obtained by the inverse reinforcement learning method from a partial series group corresponding to the purchasing stage mᵢ (for example, s1, . . . , s12).

As described above, the transition probability P(mᵢ|mᵢ₋₁) of the purchasing stage can be estimated by the HMM. Further, the output probability P(sⱼ|mᵢ) in the area sⱼ for each purchasing stage mᵢ can be estimated by the inverse reinforcement learning method on the basis of the state transition series (traffic line) in the stage mᵢ.

This can divide the state transition series represented by traffic line information 22, for each purchasing stage.

### [3] Other Example of Output of Prediction Result

Controller 40 may propose a layout change such that another item of goods in a predetermined relation to a predetermined item of goods is put on a leaving-shop traffic line after being divided into the purchasing stages, and may display, for example, the proposed layout change on display 50. The other item of goods in the predetermined relation is, for example, an item of goods that is often purchased together with the predetermined item of goods.

If controller 40 has input a plurality pieces of goods-layout change information 25 via operation unit 30, controller 40 calculates the transition probability P(sᵢ₊₁|sᵢ) after the change of goods layout on the basis of each of the input pieces of goods-layout change information 25.

On the basis of the result, the transition probability P(sₐ→s_{b}) of a predetermined path may be calculated. Then, the goods-layout change information 25 with which the transition probability P(sₐ→s_{b}) of a predetermined path is high may be selected from a plurality of pieces of goods-layout change information 25, and the selected piece of goods-layout change information 25 may be output to display 50, for example.

The exemplary embodiments have been described to illustrate the techniques according to the present disclosure. For that purpose, the accompanying drawings and the detailed description have been provided. Therefore, in order to illustrate the above techniques, the components described in the accompanying drawings and the detailed description not only include only the components necessary to solve the problem but also can include components unnecessary to solve the problem. For this reason, it should not be immediately recognized that those unnecessary components are necessary just because those unnecessary components are described in the accompanying drawings and the detailed description.

In addition, because the above exemplary embodiments are for illustrating the techniques in the present disclosure, various modifications, replacements, additions, removals, or the like can be made without departing from the scope of the accompanying claims or the equivalent thereof.

Note that, the shop in the present exemplary embodiments may be a predetermined region. In that case, the plurality of areas in the shop are a plurality of zones in the predetermined region.

### INDUSTRIAL APPLICABILITY

The prediction device of the present disclosure enables prediction of the traffic lines of shoppers after a layout change of goods; therefore, the prediction device is useful for various devices that provide users with information of such layout positions of goods that increases the sales.

### REFERENCE MARKS IN THE DRAWINGS

1 prediction device
10 communication unit (obtaining unit)
20 storage
21 goods-layout information
22 traffic line information
23 purchased goods information
24 action model information
30 operation unit (obtaining unit)
40 controller
41 first characteristic vector generator
42 model generator
42a traffic line information divider
42b reward function learning unit
43 goods-layout information corrector
44 second characteristic vector generator
45 traffic line prediction unit
50 display

1. A prediction device that predicts a flow of a person after a layout change of goods in a region, the prediction device comprising:
an obtaining unit that obtains traffic line information representing flows of a plurality of persons in the region, layout information representing layout positions of the goods, and change information representing a layout change of the goods; and
a controller that generates an action model of a person in the region, by an inverse reinforcement learning method, based on the traffic line information and the layout information and that predicts a flow of a person after the layout change of the goods, based on the action model and the change information.

2. The prediction device according to claim 1, wherein
the region includes a plurality of zones,
the traffic line information represents at least one of the plurality of zones, the at least one of plurality of zones being zones that each of the plurality of persons passed through, and
the controller employs the plurality of zones as a plurality of states in the inverse reinforcement learning method, respectively, and generates the action model by learning a plurality of rewards in the inverse reinforcement learning method, based on the traffic line information, the plurality of rewards being associated with the plurality of states.

3. The prediction device according to claim 2, wherein the controller generates, based on the layout information, zonal characteristic information representing at least one item of the goods that is obtainable in each of the plurality of zones, and the zonal characteristic information represents each of the plurality of states in the inverse reinforcement learning method.

4. The prediction device according to claim 2, wherein the controller calculates the plurality of rewards after the layout change of the goods, based on the action model and the change information.

5. The prediction device according to claim 4, wherein the controller determines, based on the plurality of rewards after the layout change of the goods, a strategy representing an action that a person in the region is to take in each of the plurality of states.

6. The prediction device according to claim 5, wherein the controller calculates, based on the determined strategy, a transition probability of a person between two of the plurality of zones after the layout change of the goods.

7. The prediction device according to claim 1, wherein
the obtaining unit further obtains purchased goods information representing one or more goods among the goods, the one or more goods being purchased by the plurality of persons in the region, and
the controller performs grouping on the plurality of persons, based on the purchased goods information, and generates the action model, based on the traffic line information after the grouping.

8. The prediction device according to claim 1, wherein the controller divides each of the flows of the plurality of persons into a plurality of purchasing stages, based on the traffic line information, and generates the action model for each of the plurality of purchasing stages.

9. The prediction device according to claim 8, wherein the controller determines the plurality of purchasing stages by a hidden Markov model.

10. The prediction device according to claim 1, further comprising an output unit that outputs the predicted flow of a person.

11. A prediction method for predicting a flow of a person after a layout change of goods in a region, the prediction method comprising:
obtaining traffic line information representing flows of a plurality of persons in the region, layout information representing layout positions of the goods, and change information representing a layout change of the goods;
generating an action model of a person in the region by an inverse reinforcement learning method, based on the traffic line information and the layout information; and
predicting a flow of a person after the layout change of the goods, based on the action model and the change information.
